(19) United States
(12) Patent Application Publication
(10) Pub. No.: US 2017/0123959 A1
(43) Pub. Date: May 4, 2017

(54) OPTIMIZED INSTRUMENTATION BASED ON FUNCTIONAL COVERAGE

(71) Applicant: International Business Machines Corporation, Armonk, NY (US)

(72) Inventors: Howard M Hess, Winnetka, IL (US); Deborah A Odell, Staatsburg, NY (US); Itai Segall, Tel-Aviv (IL); Aviad Zlotnick, Mitzpeh Netofah (IL)

(73) Assignee: International Business Machines Corporation, Armonk, NY (US)

(21) Appl. No.: 13/888,386

(22) Filed: May 7, 2013

(51) Int. Cl. G06F 11/36

(52) U.S. Cl. CPC G06F 11/3644; G06F 11/3636; G06F 11/3676; G06F 11/3684

(57) ABSTRACT

A method, apparatus, and computer-implemented method for optimized instrumentation based on functional coverage, the method comprising: receiving a set of states, the set of states defining required coverage of a program under test, each state of the set of states comprising a value of one or more controllable parameters and a value of one or more incontrollable parameters; executing the program under test and obtaining one or more runtime traces; comparing a value of the incontrollable parameters in the runtime trace to a value of the incontrollable parameters in one or more of the states; and responsive to the values of the incontrollable parameters in the runtime trace being equal to the values of the incontrollable parameters in any of the states, setting a value of one or more controllable parameters to the value of the one or more controllable parameters in the state.

### TECHNICAL FIELD

The present disclosure relates to testing in general, and to a method and apparatus for instrumenting code, in particular.

### BACKGROUND

Computerized devices control almost every aspect of our life—from writing documents to controlling traffic lights. However, computerized systems are bug-prone, and thus require a testing phase in which the bugs should be discovered. The testing phase is considered one of the most difficult tasks in designing a computerized device. The cost of not discovering a bug may be enormous, as the consequences of the bug may be disastrous. For example, a bug may cause the injury of a person relying on the designated behavior of the computerized system. Additionally, a bug in hardware or firmware of a marketed product may be expensive to fix, as patching it requires call-back of the computerized device. Hence, many developers of computerized systems invest a substantial portion of the development cycle to discover erroneous behaviors of the computerized device.

An important part of testing relates to test planning and design, i.e., providing a set of tests that cover the system in accordance with the requirements, so that if all tests pass, then the system is assumed to be operative. However, it is generally required to increase testing efficiency and reduce the number or total cost of the tests as much as possible.

A common methodology for test planning and design comprises the usage of combinatorial models, also referred to as Cartesian-product models, which may be used when describing a problem as a set of attributes or properties, values corresponding to the attributes, and restrictions on combinations of values that may not appear together in a test. Each test comprises a value for each attribute, such that the combination represents a particular situation. Thus, a test may be represented as a tuple in which every attribute is assigned a value, and the model therefore spans a space of valid tests, being the value assignments that do not violate any restrictions.

Combinatorial models may have several usages, one of which may be as the input to Combinatorial Test Design (CTD), a test planning technique that selects a subset of the valid test space which covers all interactions up to a certain level, which may be user-defined. For example, a user may require that the system be tested on all pairwise combinations, e.g., if the system has four variables A, B, C and D, each having two possible values, it is required to test the combinations of A₁-B₁, A₁-B₂, A₂-B₁, A₂-B₂ and similarly for all other pairs. However, it will be appreciated that A₁-B₁ can be tested together with C₁-D₁ and A₂-B₂ with C₂-D₂, such that it is not required to further test A₁-B₁ with C₂-D₂. Another important usage is for analysis of functional coverage of systems.

One obstacle of CTD deployment lies in the inability to generate some or all the attribute combinations required for one or more tests. Some of the parameters may be incontrollable by a user, such as memory state, a lock, or the like, thus some or all of the full combinations may not be achieved and therefore cannot be tested.

### BRIEF SUMMARY

One aspect of the disclosure relates to a computer-implemented method performed by a computerized device, comprising: receiving a set of states, the set of states defining required coverage of a program under test, each state of the set of states comprising a value of one or more controllable parameters and a value of one or more incontrollable parameters; executing the program under test and obtaining one or more runtime traces; comparing a value of the incontrollable parameters in the runtime trace to a value of the incontrollable parameters in one or more of the states; and responsive to the values of the incontrollable parameters in the runtime trace being equal to the values of the incontrollable parameters in any of the states, setting a value of one or more controllable parameters to the value of the one or more controllable parameters in the state.

Another aspect of the disclosure relates to an apparatus having a processing unit and a storage device, the apparatus comprising: a coverage analysis component for generating a set of states providing coverage of a program under test for which it is required to determine if a coverage goal is met, each state of the set of states comprising one or more values of one or more controllable parameters and a one or more values of one or more incontrollable parameter; a program execution component for executing the program under test; a trace comparison component for comparing one or more values of incontrollable parameters in a trace obtained from executing the program under test to one or more values of at least one incontrollable parameters in one or more of the states; and a controllable parameter setting component for setting one or more values of the one or more controllable parameter to the values of the controllable parameter in the state.

Yet another aspect of the disclosure relates to a computer program product comprising: a non-transitory computer readable medium; a first program instruction for receiving a set of states, the set of states defining required coverage of a program under test, each state of the set of states comprising a value of one or more controllable parameters and a value of one or more incontrollable parameters; a second program instruction for executing the program under test and obtaining one or more runtime traces; a third program instruction for comparing a value of the incontrollable parameters in the runtime trace to a value of the incontrollable parameters in one or more of the states; and a fourth program instruction for responsive to the values of the incontrollable parameters in the runtime trace being equal to the values of the incontrollable parameters in any of the states, setting a value of one or more controllable parameters to the value of the one or more controllable parameters in the state, wherein said first, second third and fourth program instructions are stored on said non-transitory computer readable medium.

Page 4 of 22 1L9-2012-0121

BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

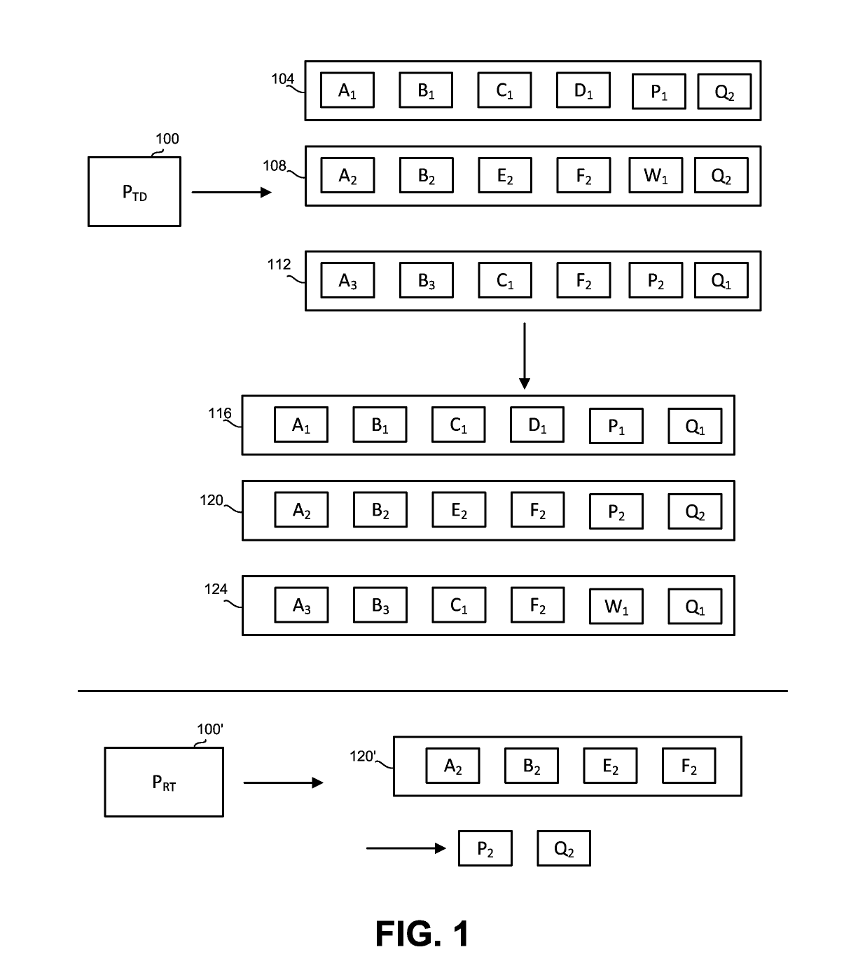

FIG. 1 shows an illustrative example of a generating and testing attribute collection comprising controllable and incontrollable parameters, in accordance with some exemplary embodiments of the disclosed subject matter;

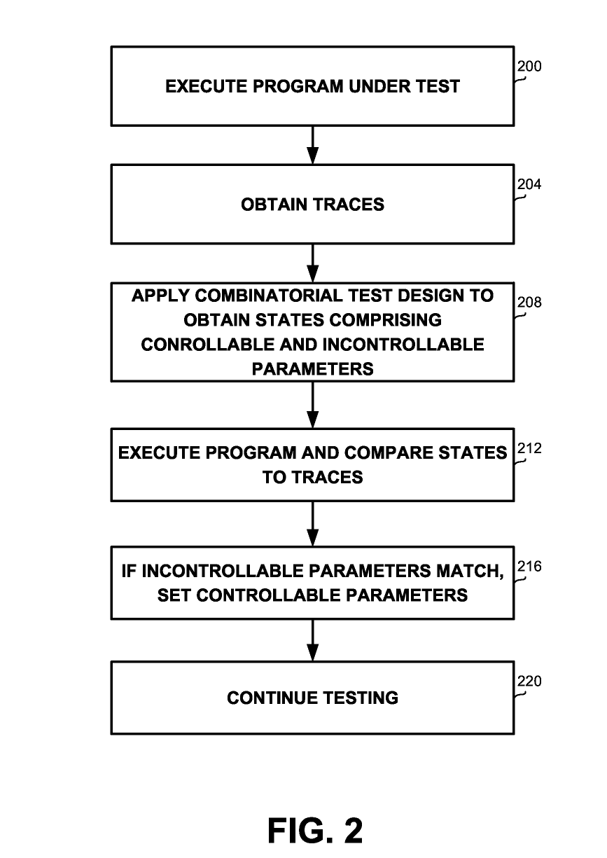

FIG. 2 shows a flowchart diagram of steps in a method for optimized instrumentation based on functional coverage, in accordance with some exemplary embodiments of the disclosed subject matter; and

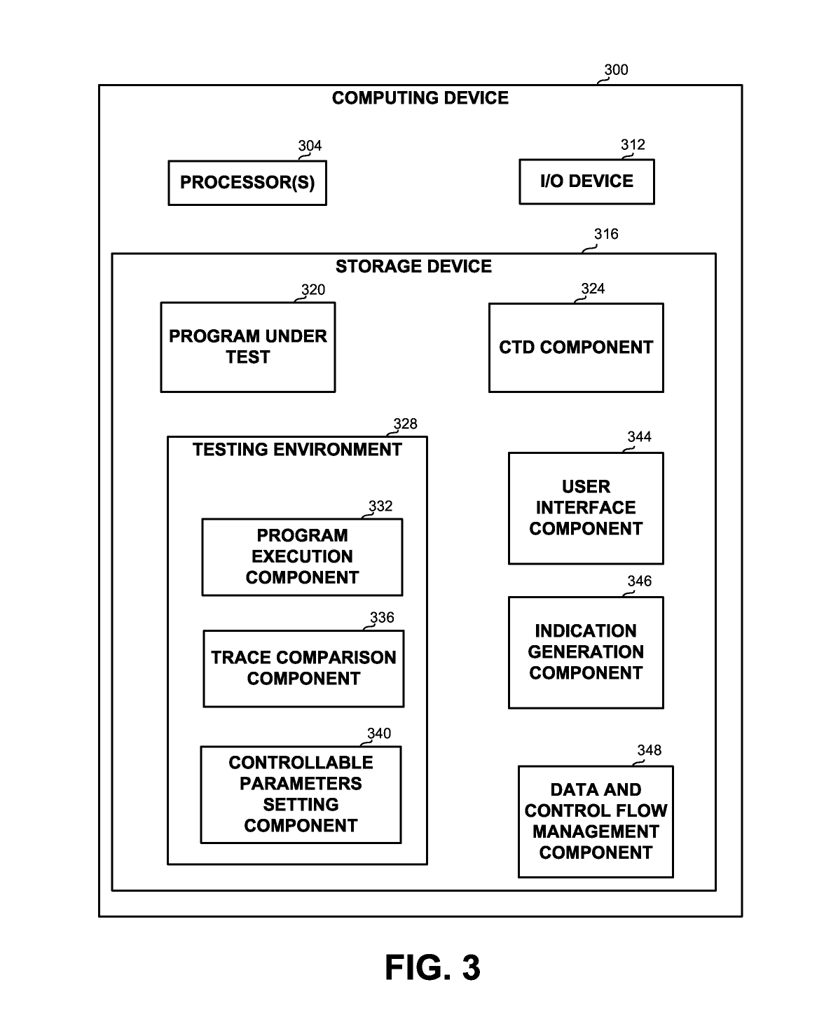

FIG. 3 shows a block diagram of components of an apparatus for optimized instrumentation based on functional coverage, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that blocks of the flowchart illustrations and/or block diagrams, and combinations of blocks in the flowchart illustrations and/or block diagrams, can be implemented by computer program instructions. These computer program instructions may be provided to one or more processors of a general purpose computer, special purpose computer, a tested processor, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transient computer-readable medium that can direct a computer or other programmable data processing apparatus to function in a particular manner, such that the instructions stored in the non-transient computer-readable medium produce an article of manufacture including instruction means which implement the function/act specified in the flowchart and/or block diagram block or blocks.

The computer program instructions may also be loaded onto a device. A computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter relates to generating test scenarios which comprise controllable or injected parameters and incontrollable parameters, such that the system under test can be tested in a variety of real-life scenarios.

When executing a computer program on a computerized device, each execution state is comprised of a multiplicity of parameters or attributes, for example the programs or services executed by the computing device at the time, for example whether a navigation system is currently executed, or is Bluetooth communication currently enabled by the device; parameters of any such program; parameters of the computing device such as memory state of the computing device, elements queued on each queue such as an event queue, whether each lock in the system is taken or not, actions in progress, or the like. Some of these parameters or attributes are controllable, for example whether a navigation system is being executed, while others are incontrollable such as memory state.

The term “controllable” may relate to variables which may be set, specified or changed by a user providing input to the system and thus, while incontrollable variables relate to parameters that are set by the computing platform depending on its internal state.

In some embodiments it is required to test the system under test in a variety of situations, related to controllable and incontrollable parameters, For example, when testing the recovery of a program from a failure, it may be required to reconstruct the full state of the machine, including the controllable as well as the incontrollable parameters.

One technical solution comprises executing the program under test one or more times, thus generating one or more traces, comprising for example the system state and in particular the incontrollable parameters at a multiplicity of points, for example when entering or exiting a function.

The trace collection may then be analyzed and a set of tests may be generated, for example by a Combinatorial Test Design engine.

One or more of the generated combinations may comprise values for the controllable parameters which may be set for example by setting triggers or parameters of the device such as enabling Bluetooth communication, or performing certain operations such as activating programs, restarting the device, or the like. One or more of the generated combinations may also comprise values for the incontrollable parameters, such as memory state, lock state, or the like. In some embodiments, the values for the incontrollable parameters comprise value combinations that have been detected in the trace collection, and combinations which have not been observed in any of the traces may be avoided. The values assigned for the controllable parameters, however, may be set to any value, such that the combinations of two or more controllable parameters or one or more controllable parameter and one or more incontrollable variables may or may have not been observed in the trace collection.

The generated states may then be stored on a storage device.

Then, in testing mode, the program may be executed one or more times.

On each such execution, a framework may check the state of the incontrollable parameters at each tracing point, and may compare the state to the states gathered and stored during the test design.

If the state at the particular time is the same, i.e., the incontrollable parameters or attributes have the same values as on one of the stored states, then the controllable parameters are set to the respective values in the state, for example the relevant operations may be taken, or the triggers may be set. It will be appreciated that the controllable parameters may be set so as to achieve maximal coverage with respect to a given set of requirements. For example, the requirements may include testing all pairs of lock state and active application. Then, when any of the possible lock states is detected, the relevant active application states may be set, thus testing the particular combination.

This provides for reconstructing a state, which includes controllable and incontrollable states, so that the required testing may be performed. For example, once the state is reconstructed, the program may be aborted, in order to test its recovery.

One technical effect of utilizing the disclosed subject matter is the generation of states, which include controllable as well as incontrollable parameters or parameters. This provides for full reconstruction of states, thus enabling testing of the system in elusive states, for example for recovery testing.

Referring now to FIG. 1, showing an illustrative example of optimized instrumentation based on functional coverage. The system may be any apparatus, such as a software system, a hardware system, a machine, a combination thereof, or the like.

The exemplary program together with its environment has six incontrollable parameters A-F, and three controllable parameters, P, Q, and W.

During one or more executions of program P_{DT} 100 in design time, three traces are collected, being traces 104, 108 and 112. Each of traces 104, 108 and 112 comprises values for four of the incontrollable parameters and two of the controllable parameters. A trace may contain values for all the parameters or for any subset of the parameters,

The traces may then undergo CTD which may create a set of states that spans the testing space, the set comprising states 116, 120 and 124. Some exemplary embodiments of CTD are provided in U.S. patent application Ser. No. 13/437,945 titled “Method and Apparatus for Reusing Parts of Existing Tests” filed on Apr. 3, 2012 and assigned to the same assignee, hereby incorporated by reference in its entirety for all purposes.

The program is then executed as process P_{RT} 100′ in run time.

The program traces are monitored. If a state is encountered for which the incontrollable parameters have the same values as the incontrollable values in a specific test in the test set, then the controllable parameters are set to the same values as the controllable parameters in the specific test. In the example of FIG. 1, if state 116′ is encountered, which has the same values for A, B, E and F parameters as state 116, then parameters P and Q are assigned the same values as test 116.

Using this scheme, a state comprising controllable as well as incontrollable parameters may be constructed by monitoring for the occurrence of one of known values combinations of the incontrollable parameters, and complementing the test with assigning the required values to the controllable parameters.

It will be appreciated that assigning a value to a parameter may also correspond to activating or deactivating a program, changing operation mode, changing privilege, or performing any other action.

Referring now to FIG. 2, showing a flowchart diagram of steps in a method for optimized instrumentation based on functional coverage.

On step 200, which may be performed during a test design stage, the program under test may be executed one or more times. The program may be executed with settings such that it generates trace files, which may comprise values for controllable as well as incontrollable parameters, which may relate to the program itself, to the computing platform or the environment, to other programs executed by the computing platform, or the like.

On step 204, the traces may be obtained. It will be appreciated that the traces may be received by the computing platform on which the program was executed, or by another computing platform, for example from a storage device which is in direct or indirect communication with the computing platform on which the program was executed.

On step 208, analysis such as combinatorial test design may be applied to the traces, to identify a set of value combinations for the parameters, which provides coverage for the program which complies with the requirements. For example, the set may provide for pairwise testing of any two parameter values, e.g., testing all combinations of parameters A and B, and independently testing all combinations of parameters C and D. Suppose A and C have the same number of possible values and similarly for B and D, then such coverage can be achieved with the same number of tests as required for testing only the combinations of A and B. In some embodiments, this analysis may be performed globally for the entire program. In other embodiments, the analysis may be performed separately for one or more subsets of the trace collection points.

At least some of the tests in the obtained state set comprise values for one or more incontrollable parameters and values for one or more controllable parameters.

It will be appreciated that a state set providing coverage of the program under test may be obtained by methods other than combinatorial test design, for example by random test generation.

In some embodiments, CTD may be performed over the incontrollable values, and optionally some of the controllable variables, such that values for the other controllable values may be provided by a user such as a testing engineer.

On step 212 the program may be executed in a testing stage, and traces may be obtained during each such execution. One or more of the obtained traces may be compared to the combinations in the test set created on step 208. The comparison may include the values of the incontrollable values only.

If the values of the incontrollable values in one of the traces match the values in a particular test of the test set, then on step 216 the controllable parameters may be set to the same values as in the particular test, thus reconstructing the full test determined during the test design.

On step 224, testing may continue to determine the execution results of the test with the required parameter value combination. For example, if the program is aborted after the parameters are set to the required values, the program recovery may be evaluated or validated. In another example, the effect of starting another program that may share resources with the executed program may be tested after having initiated the other program.

Referring now to FIG. 3, showing a block diagram of components of an apparatus for determining and presenting legality status.

The apparatus may comprise a computing platform 300. Computing platform 300 may comprise a processor 304. Processor 304 may be a Central Processing Unit (CPU), a microprocessor, an electronic circuit, an Integrated Circuit (IC) or the like. Alternatively, computing platform 300 can be implemented as firmware writen for or ported to a specific processor such as digital signal processor (DSP) or microcontrollers, or can be implemented as hardware or configurable hardware such as field programmable gate array (FPGA) or application specific integrated circuit (ASIC). Processor 304 may be utilized to perform computations required by computing platform 300 or any of it subcomponents.

In some embodiments, computing platform 300 may comprise an input-output (I/O) device 312 such as a terminal, a display, a keyboard, a touch screen, an input device or the like, used to interact with the system, to invoke the system and to receive results.

In some exemplary embodiments, comptuing platform 300 may comprise one or more storage devices such as storage device 316. Storage device 316 may be persistent or volatile. For example, storage device 316 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, storage device 316 may retain program code operative to cause processor 304 to perform acts associated with any of the steps shown in FIG. 2 above, for example executing combinatorial test design, executing the program in testing time and comparing parameter values, or the like.

The components detailed below may be implemented as one or more sets of interrelated computer instructions, executed for example by processor 304 or by another processor. The components may be arranged as one or more executable files, dynamic libraries, static libraries, methods, functions, services, or the like, programmed in any programming language and under any computing environment.

In some exemplary embodiments of the disclosed subject matter, storage device 316 may comprise program under test 320, which may be executed in test design time and in runtime, and the validity or compliance of which it is required to test.

Storage device 316 may comprise Combinatorial Test Design (CTD) component 324 for analyzing the functionality of program under test 320 as expressed in the generated traces, and for generating a state set or a test set covering the required functionality. In some embodiments, CTD component 324 may be replaced with any other component that provides coverage based on analyzing traces.

Storage device 316 may comprise testing environment 328 which may comprise program execution component 332, for executing program under test 320, such that it generates traces. Traces may be generated both at test design time, such that CTD component 324 may be used for analyzing the traces, and in runtime such that the controllable parameters may be set when the incontrollable parameters have the same values as in any of the tests in the generated test set.

Testing environment 328 may also comprise trace comparison component 336 for comparing the incontrollable parameters of a trace generated in runtime to the values of the same parameters in one or more of the states or tests generated by CTD component 324.

Testing environment 328 may also comprise controllable parameters setting component 340 for setting the values of one or more controllable parameters, for example setting a value in a configuration file, activating a program or a feature, setting a device or a program to a particular mode, or the like.

In some exemplary embodiments of the disclosed subject matter, storage device 316 may comprise user interface component 344, also referred to as man-machine-interface (MMI) module. User interface component 344 may be utilized to provide communication between the apparatus and a user, for providing input such as required testing level which may be for example any pairwise parameter combination, receiving results, reviewing traces, or the like.

Storage device 316 may further comprise indication generation component 346 for generation an indication if a value combination of the incontrollable parameters detected in the runtime trace, is different from all value combinations of the incontrollable parameters in the collected traces. Such case may indicate insufficient coverage and therefore may need to be indicated

Yet another component of storage device 316 may be data and control flow management component 348 for managing the flow of information and control between other components, for example executing program under test 320 such that it generates traces, activating CTD component 324 on the received traces, activating program under test 320 in test mode such that if the comparison indicated a known combination, the controllable parameters are set, or the like.

It will be appreciated that the method and apparatus may be enhanced to issue an alert or otherwise indicate if during runtime, a combination of incontrollable parameter values occurs, which was not observed during the trace collection runs, or is not covered by the test set. For example, if pairwise testing is required for coverage, then the test set may cover certain value combinations of A and B parameters, and certain value combinations of C and D parameters. Then, if an unknown combination of A and B occurs, an indication may be provided since the coverage provided by the test set may be insufficient.

However, if a known combination of A and B occurs, and a known combination of C and D occurs, even if there is no known combination of A, B, C and D, there is no indication for the coverage being insufficient.

It will be appreciated that multiple enhancements and modifications may exist to the method and apparatus.

The flowchart and block diagrams in the figures illustrate the architecture, functionality, and operation of possible implementations of systems, methods and computer program products according to various embodiments of the present disclosure. In this regard, each block in the flowchart and some of the blocks in the block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product.

Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, any non-transitory computer-readable medium, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed.

Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A computer-implemented method performed by a computerized device, comprising:
receiving a set of states, the set of states defining required coverage of a program under test, at least one state of the set of states comprising a value of at least one controllable parameter and a value of at least one incontrollable parameter;
executing the program under test and obtaining at least one runtime trace;
comparing a value of the at least one incontrollable parameter in the runtime trace to a value of the at least one incontrollable parameter in the at least one state; and
responsive to the value of at least one incontrollable parameter in the runtime trace, being equal to a value of the at least one incontrollable parameter in the at least one state, setting a value of at least one controllable parameter to the value of at least one controllable parameter in the at least one state.

2. The computer-implemented method of claim 1, further comprising:
receiving at least one trace from an execution of a program under test; and
processing the at least one trace to obtain the set of states.

3. The computer-implemented method of claim 2, wherein processing the at least one trace is performed by combinatorial test design.

4. The computer-implemented method of claim 2, wherein a value combination of the at least one incontrollable parameter at each state is the same as the value combination of the at least one incontrollable parameter in the at least one trace.

5. The computer-implemented method of claim 1, further comprising providing an indication if a value combination of the at least one incontrollable parameter in the runtime trace, is different from all value combinations of the at least one incontrollable parameter in the at least one trace.

6. An apparatus having a processing unit and a storage device, the apparatus comprising:
a coverage analysis component for generating a set of states providing coverage of a program under test for which it is required to determine if a coverage goal is met, at least one state of the set of states comprising a value of at least one controllable parameter and a value of at least one incontrollable parameter;
a program execution component for executing the program under test;
a trace comparison component for comparing a value of the at least one incontrollable parameter in a trace obtained from executing the program under test to a value of the at least one incontrollable parameter in the at least one state; and
a controllable parameter setting component for setting a value of the at least one controllable parameter to the value of at least one controllable parameter in the at least one state.

7. The apparatus of claim 6, wherein the coverage analysis component is a combinatorial test design component.

8. The apparatus of claim 6, further comprising an alert generation component for providing an indication if a value combination of the at least one incontrollable parameter in the runtime trace, is different from all value combinations of the at least one incontrollable parameter in the at least one trace.

9. The apparatus of claim 6, further comprising a user interface component for entering data or receiving results from the apparatus.

10. A computer program product comprising:
a non-transitory computer readable medium;
a first program instruction for receiving a set of states, the set of states defining required coverage of a program under test, at least one state of the set of states comprising a value of at least one controllable parameter and a value of at least one incontrollable parameter;
a second program instruction for executing the program under test and obtaining at least one runtime trace ;
a third program instruction for comparing a value of the at least one incontrollable parameter in the runtime trace to a value of the at least one incontrollable parameter in the at least one state; and
a fourth program instruction for responsive to the value of at least one incontrollable parameter in the runtime trace, being equal to a value of the at least one incontrollable parameter in the at least one state, setting a value of at least one controllable parameter to the value of at least one controllable parameter in the at least one state,
wherein said first, second third and fourth program instructions are stored on said non-transitory computer readable medium.
